(19) United States
(12) Patent Application Publication
(10) Pub. No.: US 2007/0233668 A1
(43) Pub. Date: Oct. 4, 2007

(54) Method, system, and computer program product for semantic annotation of data in a software system

(75) Inventor: Kirill M. Osipov, Ormond Beach, FL (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/396,796

(22) Filed: Apr. 3, 2006

(51) Int. Cl. G06F 17/30

(52) U.S. Cl. 707/5

(57) ABSTRACT

A method, system, and program product for rapid semantic annotation of data in a software system is disclosed. The method may include receiving an annotated portion of a data set; and producing a recommended annotation for a data sample of the data set, wherein the recommended annotation is derived from the received annotated portion. The recommended annotation may be a ranked list of potential semantic associations and/or a hierarchy of all available semantic associations. The software system may be a learning system. Significant time (both overall and with each annotation) is saved in the semantic annotation process.

### BACKGROUND OF THE INVENTION

1. Field of the Invention

The present invention relates generally to the field of learning systems software. More specifically, the present invention provides a method, system, and computer program product for semantic annotation of data in a software system.

2. Background Art

Supervised training is a commonly used approach to improve performance of software systems that process large quantities of complex, highly variable data. One type of software system, herein referred to as learning systems, are common in fields such as speech recognition, video analysis, and text search and categorization. Often used within supervised training is a process called semantic annotation in which a representative subset of the data that is expected to be processed is identified and supplemented with additional information.

For example, in the context of a speech recognition application being used in a bank customer service contact center environment, natural language text data may be supplemented with semantic annotation. One sample could be text data in the form of the sentence: “I want my balance.” A conceivable semantic annotation may be associated with this entire sentence (i.e., sample) via a semantic label such as “BALANCE” to indicate that the sentence is asking for the balance of an account.

In the area of video analysis, for example, snippets or thumbnails of video images may be semantically annotated using icons in lieu of text labels. For example, an image of a pasture may be annotated by selecting two segments of images. One segment may contain a cow, and another segment may contain grass. These segments may be annotated with a cow icon and a grass icon, respectively.

In learning systems that employ supervised training, the greater the quantity of semantically annotated data, the better the overall performance of the learning system. For example, with speech recognition systems, the greater the quantity of natural language text samples that are used to “train” the system, the more robust and accurate the recognition.

This goal of increasing annotated data quantity creates a dilemma. One of many disadvantages is that more time has to be spent to annotate the entire dataset. Concomitantly, more time has to be spent annotating each sample in the dataset because the larger dataset impliedly has a larger set of semantic classes available for annotation.

In view of the foregoing, there exists a need for a method, system, and program product for providing semantic annotation of data in a software system, such as a learning system, that addresses the problems discussed herein and/or other problems recognizable to one in the art.

### SUMMARY OF THE INVENTION

In general, a method, system, and program product for rapid semantic annotation of data in a software system is disclosed. The method may include receiving at the software system an annotated portion of a data set; and producing a recommended annotation for a data sample of the data set, wherein the recommended annotation is derived from the received annotated portion. The recommended annotation may be a ranked list of potential semantic associations and/or a hierarchy of all available semantic associations. The software system may be a learning system. Significant time (both overall and with each annotation) is saved in the semantic annotation process.

A first aspect of the present invention provides a method of semantic annotation of data in a software system, comprising: receiving an annotated portion of a data set; and producing a recommended annotation for a data sample of the data set, wherein the recommended annotation is derived from the received annotated portion.

A second aspect of the present invention provides a method of semantic annotation of data in a software system, comprising: providing a data set; receiving a selected sample from the data set; and providing a recommended semantic association for the selected sample.

A third aspect of the present invention provides a system for semantic annotation of data in a software system, comprising: a system for receiving an annotated portion of a data set; and a system for producing a recommended annotation for a data sample of the data set, wherein the recommended annotation is derived from the received annotated portion.

A fourth aspect of the present invention provides a program product stored on a computer readable medium for providing semantic annotation of data in a software system, the computer readable medium comprising program code for performing the steps of: receiving an annotated portion of a data set; and producing a recommended annotation for a data sample of the data set, wherein the recommended annotation is derived from the received annotated portion.

A fifth aspect of the present invention provides a method for deploying an application for providing semantic annotation of data in a software system, comprising: providing a computer infrastructure being operable to: receive an annotated portion of a data set; and produce a recommended annotation for a data sample of the data set, wherein the recommended annotation is derived from the received annotated portion.

A sixth aspect of the present invention provides computer software embodied in a propagated signal for providing semantic annotation of data in a software system, the computer software comprising instructions to cause a computer system to perform the following functions: receiving to an annotated portion of a data set; and producing a recommended annotation for a data sample of the data set, wherein the recommended annotation is derived from the received annotated portion.

Therefore, the present invention provides a method, system, and a computer program product for providing semantic annotation of data in a software system.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts an example of a system diagram for semantic annotation of a learning system, of the related art.

FIG. 2 depicts a system diagram for semantic annotation of data in a software system, in accordance with an embodiment of the present invention.

FIG. 3 depicts an embodiment of a user interface for providing semantic annotation of data in a software system, in accordance of the present invention.

FIG. 4 depicts another embodiment of a user interface for providing semantic annotation of data in a software system, in accordance of the present invention.

FIG. 5A depicts an embodiment of an example of a user interface showing the annotation of a data sample, for providing semantic annotation of data in a software system, in accordance of the present invention.

FIG. 5B depicts an embodiment of an example of a user interface showing a ranked list, for providing semantic annotation of data in a software system, in accordance of the present invention.

FIGS. 6A-6C depict flowcharts of various portions of a method for providing semantic annotation of data in a software system, in accordance with an embodiment of the present invention.

FIG. 7 depicts a computerized system for providing semantic annotation of data in a software system, in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, the present invention provides a method, system and program product for providing semantic annotation of data in a software system.

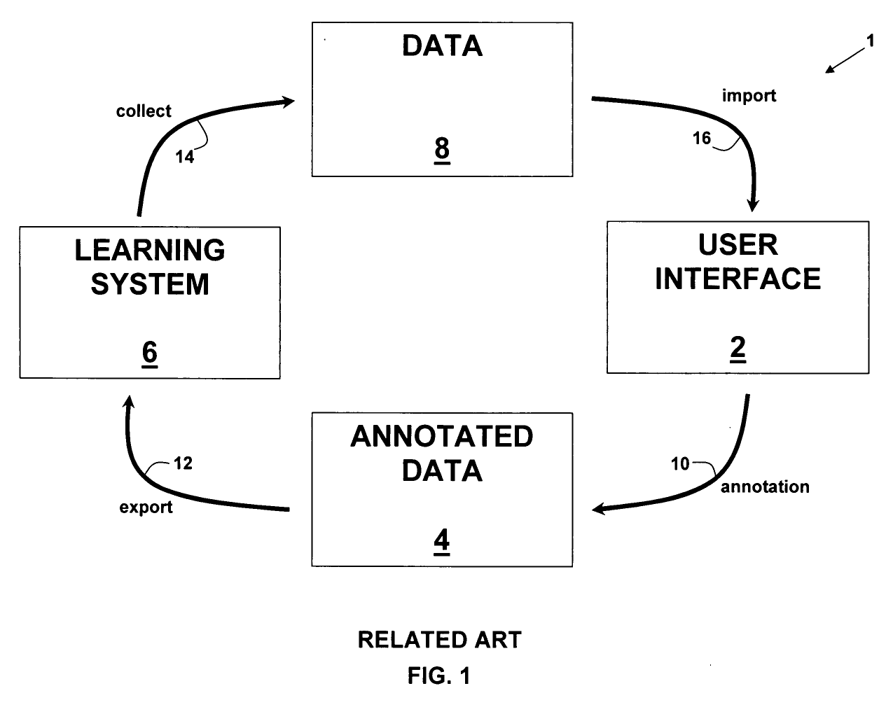

A typical system 1 for providing for semantic annotation in a learning system environment is shown in FIG. 1. The system 1 includes a user interface 2, annotated data 4, a learning system 6, and data (or data set) 8. The system 1 acts cyclically in that the user interface 2 allows for a user (not shown) to see data 8 that has been imported and offer the opportunity for annotation 10 of the data 8, leading to annotated data 4. The annotated data 4 is exported 12 to the learning system 6. From the learning system 6, data 8 may be collected 14. The data 8 may be then imported 16 back to the user interface 2 for interaction with the user. FIG. 1 ultimately demonstrates the system 1, or “lifecycle” of how a user(s) interacts with data 8 during supervised training of a learning system 6.

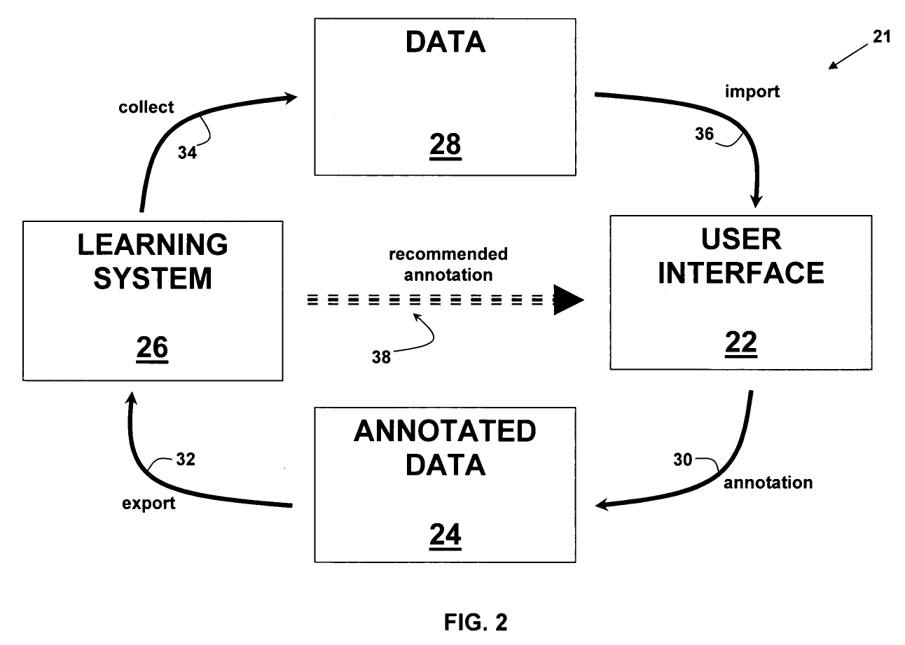

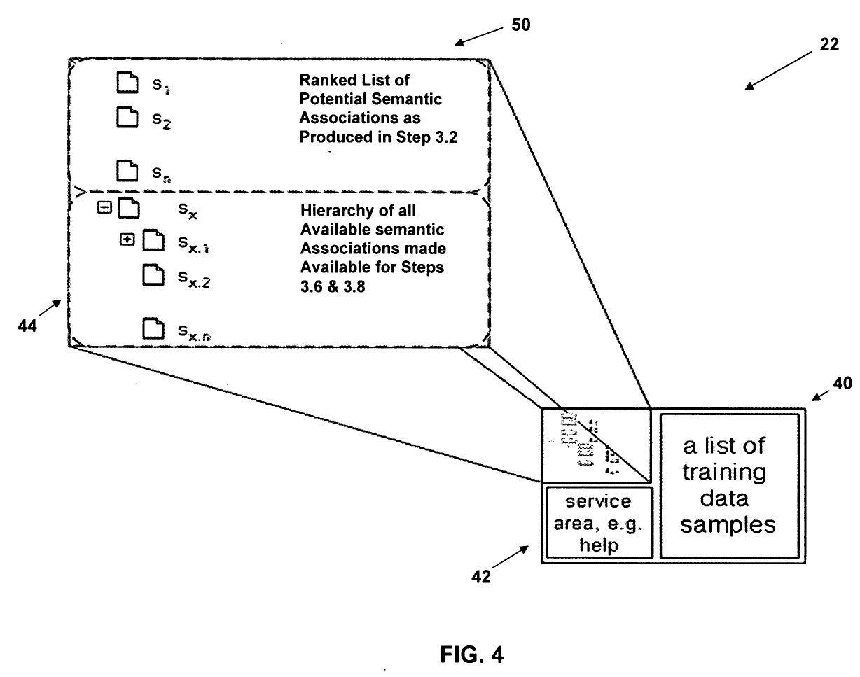

An improved system 21 for providing semantic annotation of data in a software system, employing an embodiment of the present invention is shown in FIG. 2. The system 21 includes a user interface 22, annotated, or training, data 24, a software system 26 (e.g., “learning system”), and data 28. Similarly, the user interface 22 can provide for the opportunity for a user (not shown) to annotate 30 data 28 so as to provide annotated data 24. The annotated data 24 is exported 32 to the learning system 26, thereby improving the quality of the learning system 26. From the learning system 26, data 28 may be collected 34. The data 28 may be then imported 36 back to the user interface 22. The system 21 of the present invention further includes the augmentation of further providing recommended annotations 38 from the learning system 26 to the user interface 22 before the entire data 28 has been annotated 30 into the annotated data 24. The recommended annotations 38 are shown via a dashed line in FIG. 2. These recommended annotations 38 may be in the form of hierarchically organizing all available semantic associations (i.e., “hierarchy”) 44 (see e.g., FIG. 4) and/or providing a ranked list of potential semantic associations 50 (i.e., “ranked list”) (see e.g., FIG. 4) to the user in a dynamic, ongoing fashion.

Software system 26 may be, for example, a learning system such as those that are common in fields such as speech recognition, video analysis, and text search and categorization. However, other software systems 26 now known, or later developed, may be used under the present invention wherein semantic annotation may be utilized.

The present invention may include the software system 26 (e.g., learning system) receiving at least one portion of annotated data 24 from an entire portion of data 28, wherein the annotated data 24 is less than the entire portion of data 28. From this received annotated data 24, the software system 26 produces a recommended annotation 38 for any future data sample of the data 28, wherein the recommended annotation 38 is derived from the previously received annotated data 24. The future data sample may be, for example, at least one sample selected from the data 28, wherein the sample requires semantic annotation.

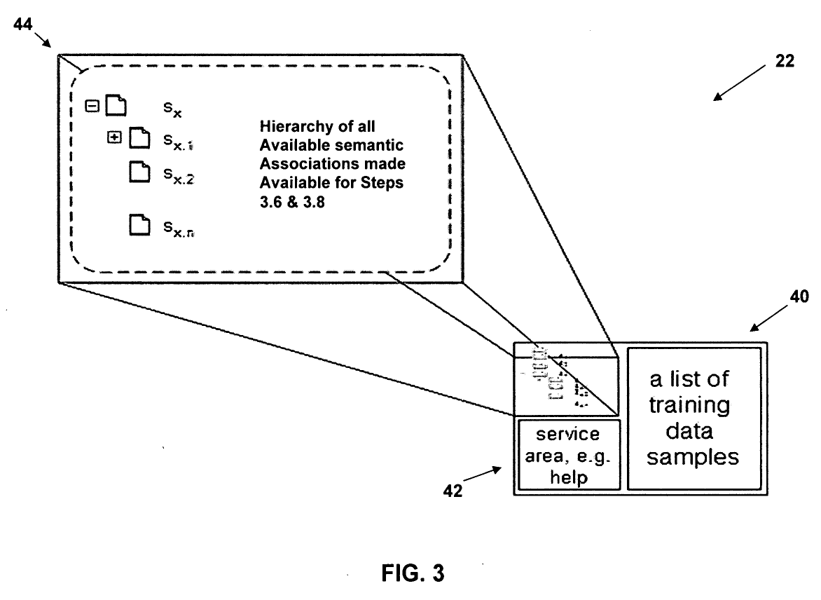

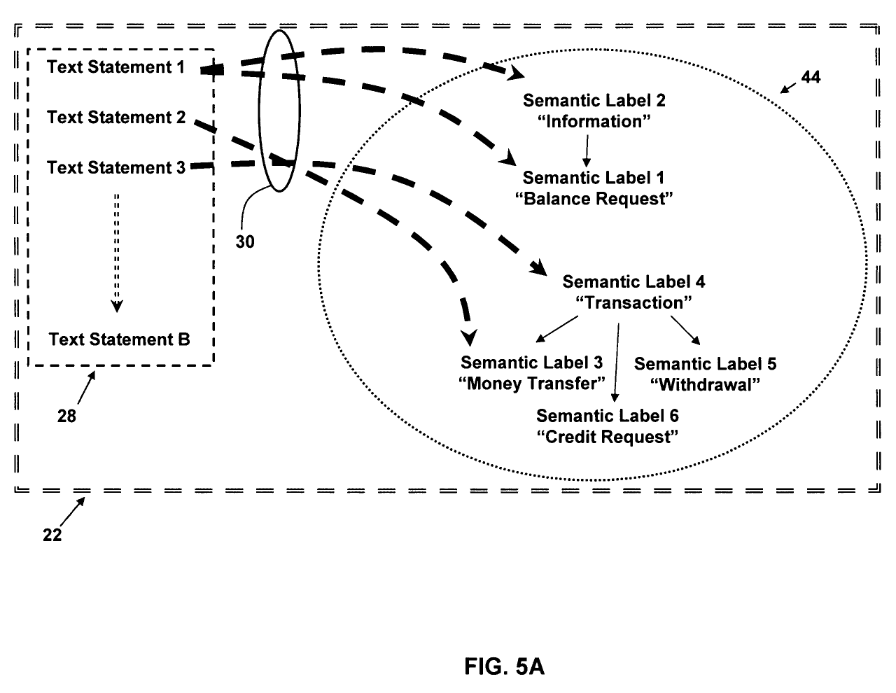

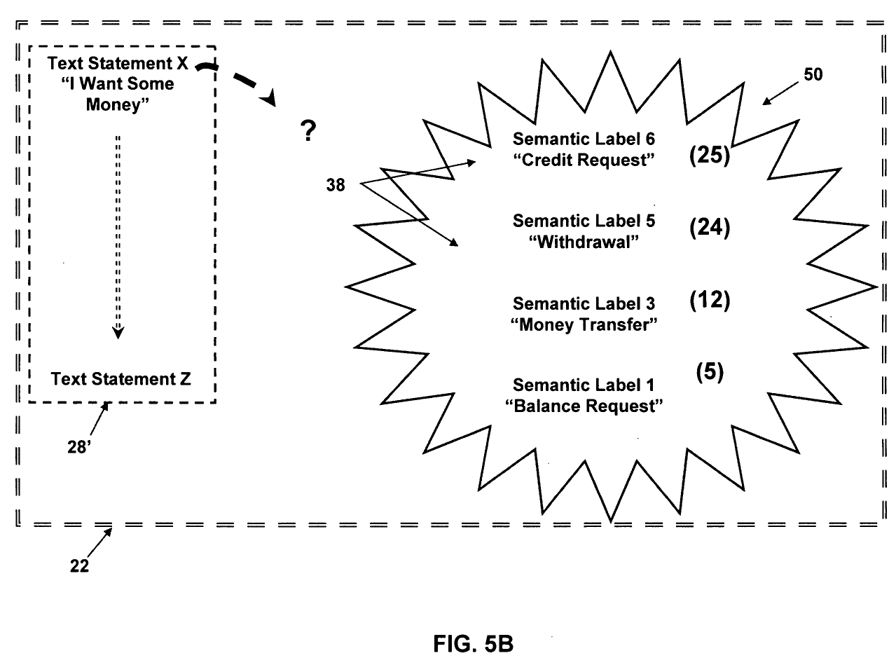

Embodiments of user interfaces 22, in accordance with aspects of the present invention, are depicted in FIGS. 3 and 4 as well as FIGS. 5A and 5B. The interfaces 22 may depict various aspects, or logical areas, including a list of training data samples 40 (e.g., annotated data 24 as in FIG. 2), a service (e.g., “help”) area 42, a hierarchy of all available semantic associations 44, a ranked list of potential semantic associations 50 (FIG. 4), and other possible aspects (not shown). Other depictions, variations, permutations, views, and the like, both now known and later developed are contemplated under the aegis of the term user interface 22.

The hierarchy 44 provides the user at the user interface 22 with a set of semantic labels before enough data samples have been annotated so as to produce the ranked list 50. Additionally, the hierarchy 44 provides the user at the user interface 22 with access to the semantic labels which have not been chosen by the learning system 26 as elements in the ranked list 50. This offers an advantage in the case when the learning system 26, for example, makes a mistake (e.g., the ranked list 50 contains labels “A” through “D”; yet, the user wants to use label “E”), and the user may use the hierarchy 44 to find the desired label (e.g., label “E”) for use in the annotation. Ultimately, time is saved in the semantic annotation process, thereby improving the overall performance of the learning system 26 and system 21, in general.

Using a speech-enabled application environment as an example, significant time must be spent annotating text statements with application-specific semantic labels. For example, the text statement requiring annotation may be “I want my account balance”. A user, needing to annotate the text statement, must peruse, and choose, from a list (not shown) of annotation labels. This list is typically large and the quantity of annotation labels on the list can be of the order of 100 labels. The user might spend several seconds (e.g., 1-5 seconds) searching the list of all semantic labels for each of the text statements that are to be annotated.

Further, depending on the application, the total quantity of text statements that require annotation can range up to, for example, 50,000 items. As stated above, each of these text statements require annotation. The lookup, or searching, task of the list of labels takes time for each of the text statements. Taking the hypothetical example discussed above, presuming it takes 5 seconds to search the 100 annotation label list for each of the 50,000 text statements in an effort to semantically annotate the text statements, would take a cumulative time of 250,000 seconds (i.e., 4,167 minutes; or, approx. 69.5 manhours).

FIG. 3 shows the user interface 22 that provides the hierarchy 44 of all available semantic associations as made available under Steps 3.6 and 3.8 (see FIG. 5B). The hierarchy 44 has not yet been dynamically populated with an ordered list of candidate semantic labels (i.e., dynamic list 50), as shown in FIG. 4. This hierarchy 44 must exist before data is annotated because the available semantic associations are ultimately chosen from the hierarchy 44. The hierarchy 44 (e.g., Sₓ) may include a plurality of all available semantic associations (e.g., S_{x,1}; S_{x,2}; . . . ; S_{x,n}). For example, in a banking speech recognition application, the plurality of all available semantic associations may include semantic labels such as: BALANCE, TRANSFER, REQUEST-CREDIT, and WITHDRAWAL to represent various actual banking transactions such as a Request For Balance, Command to Transfer Money Between Accounts, Request a Credit Line, and Withdraw Cash, respectively.

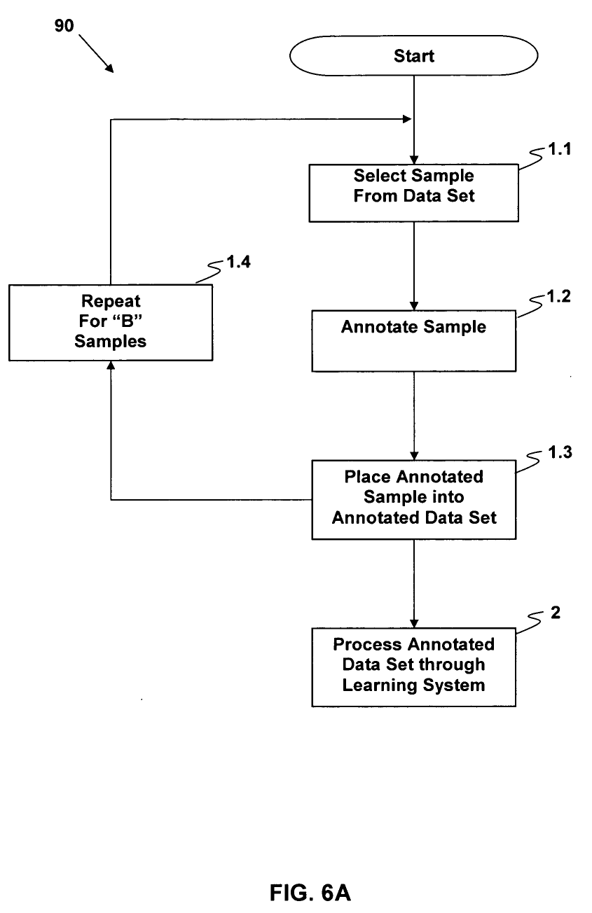

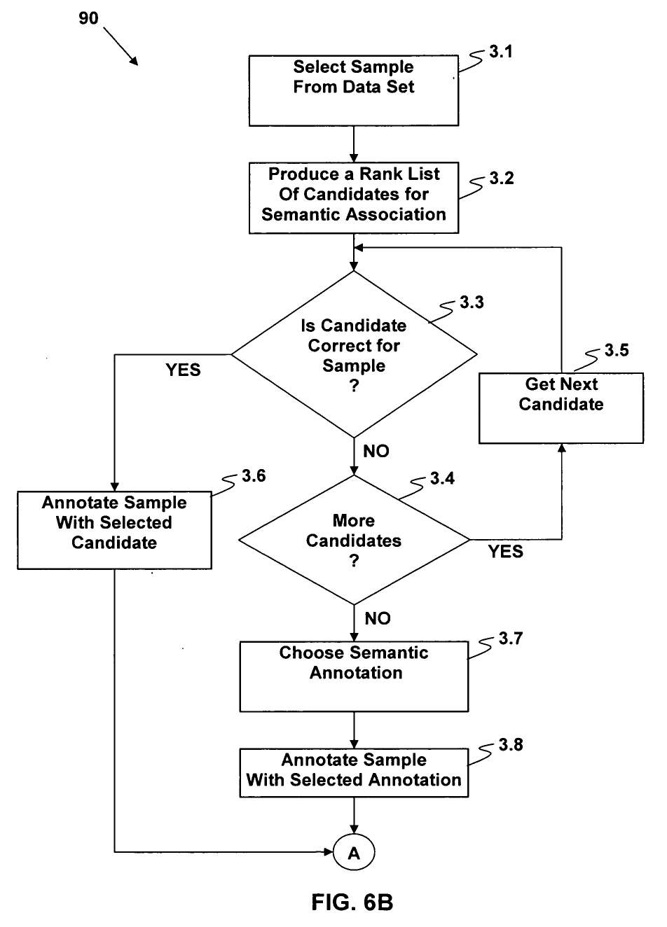

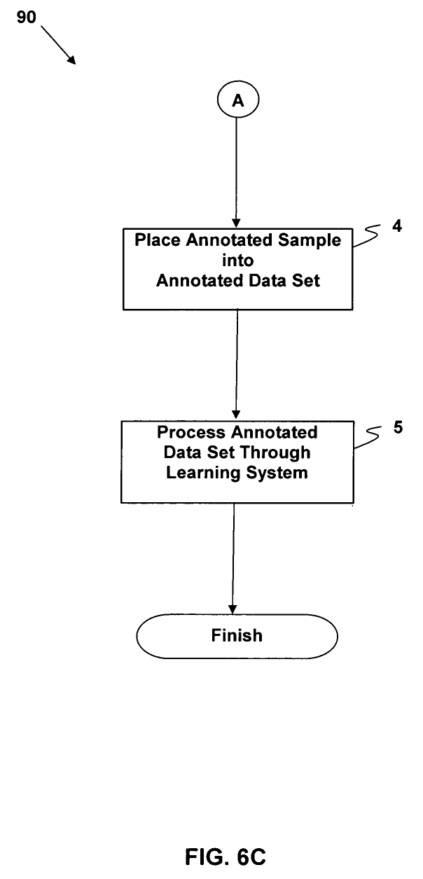

A flowchart of a method 90 for providing semantic annotation of data samples in a software system is depicted across FIGS. 6A through 6C. The first portion of the method 90, shown at FIG. 5A, starts with selecting a sample from the data set, at Step 1.1. In Step 1.2, the selected sample is annotated by associating the sample with one (or more) semantic annotations. The annotated sample is then placed into the annotated data set (Step 1.3). The Steps 1.1 through 1.3 are repeated for a quantity of “B” samples, as in Step 1.4, wherein “B” is a quantity of samples that is sufficient to achieve a measurable performance improvement in the learning system. Upon the placement of annotated samples into the annotated data set (in sufficient and/or a “B”) quantity, Step 2 follows, wherein the annotated data set is processed through the learning system so as to improve its performance. By improving the learning system first, the subsequent ranking list 50 (see FIG. 4) that is provided to the user at user interface 22 is possible.

FIG. 4 depicts the user interface 22 further wherein a dynamic list (or ranked list) 50 of candidate semantic associations is shown. By dynamic, it is meant to include the definition that the ranked list 50 is continually and/or periodically being updated, adjusted, and re-ordered. The dynamic list 50 shows the likelihood that a semantic association is an appropriate candidate for a particular sample of data. The dynamic list 50 is derived from the recommended annotations produced by the learning system 26 and is produced in Step 3.2 (FIG. 6B). The dynamic list 50 may include a direct output of the learning system 26, ranked by the learning system's 26 score of a likelihood, or probability, that a label is the correct label for a given data sample. The ranked list 50 of potential semantic associations may be provided as the following: S₁, S₂, . . . Sₙ, wherein S₁ is the most likely, highest candidate, or highest ranked candidate for being the correct semantic association for a given, selected sample; S₂ is the second most likely, etc. For example, in a context of a speech recognition application, a user may make a statement “I want some money”. Consequently, the learning system 26 may recognize that the user could be asking for “Credit”, or asking to “Make a Withdrawal”, and consequently may rank the possible semantic labels in the following order (by example only):

| | |
|---|---|
| Credit Request | (25) |
| Withdrawal | (24) |
| Transfer | (12) |
| Balance | (5) |

The illustrative scores after each semantic label indicate the learning system's 26 confidence that a given label is correct for the particular data sample (See e.g., FIG. 5B).

Turning to FIGS. 5A and 5B, specific examples of the user interface 22 are shown wherein the first portion of the method 90 (i.e., the steps in FIG. 6A), are depicted in FIG. 5A. A portion, or sample, of data 28 that is less than the entire set of data 28 is presented to the user. The user then annotates 30 the various text statement with the plurality of available semantic annotations (e.g., labels), typically provided in a hierarchical fashion 44. As shown, the text statements (e.g., “Text statement 1”, “Text Statement 2”, “Text Statement 3”, etc.) may be annotated to one, or more than one, available semantic annotations. Alternatively, the semantic annotations may be in a list form (i.e., unranked list). Upon the completion of this annotation process of this sample, or portion, of data 28, this annotated data 24 set is processed through the software system 26 (See e.g., step 2 at FIG. 6A).

As FIG. 5B, depicts, once the annotated data 24 has been processed, additional data 28′ may be presented at the user interface 22. Then when a text statement is selected for prospective annotation, the ranked list 50 that includes the recommended annotation 38 as derived from aforementioned annotated data 24 is produced, by the software system 26, and presented at the user interface 22. As discussed above, for example, the text statement “I want some money” may produce the ranked list 50 as shown, wherein inter alia, the recommended annotation 38 is led by semantic label “Credit Request” with a score of “25”.

Portions of the method 90 shown in FIGS. 6B and 6C modify the training process so that ultimately the user, through the improved user interface 22 (FIG. 4), is able to radically speed up the process of semantic annotation of the data samples. Specific improvements may include less time spent on annotating each sample, regardless of the size of the data set, because the ranked list 50 of potential semantic associations is independent of the size of the data set. Further, less time is spent on the entire annotation process, because the user can select an appropriate semantic association quicker given the ranked list 50 of potential semantic associations (See e.g., FIG. 5B).

FIGS. 6B and 6C show the portion of the method 90 that ultimately provides the ranked list 50 as shown in the user interface 22 in FIGS. 4 and 5B. Step 3.1 starts with selecting a sample from the data set. The learning system 26 produces a ranked list 50 of candidates to be the semantic association for the selected sample (Step 3.2). Steps 3.3 through 3.8 are steps and “loops” that effectively amount to producing an annotated sample for placement into the annotated data set, at Step 4 (FIG. 6C).

More specifically, however, the method 90 includes a step wherein the ranked list 50 of candidates for semantic association is produced and provided to the user (Step 3.2). If the user judges that the first (i.e., highest ranking) semantic association on the ranked list 50 is the correct semantic association for the selected sample (i.e., “Yes” reply to Step 3.3), then Step 3.6 follows, wherein the sample is annotated by associating the appropriate semantic association with the sample.

If, however, the highest rated semantic association is not the correct semantic association for the sample (i.e., result of Step 3.3 is “No”), then Steps 3.4 and 3.5 follow wherein the user is able to go down the ranked list 50 until the desired candidate is selected from the ranked list 50 of candidate semantic associations for the sample. Ultimately, the user chooses from the ranked list 50 the appropriate semantic association, or, if unsuccessful, Step 3.7 follows, wherein the user can choose from the hierarchy 44 (FIG. 4) of all available semantic associations, via an arbitrary annotation specified by the user (e.g., user defined), or the like. Regardless of the methodology employed by the user, the sample is annotated with the selected choice by associating the sample with the semantic annotation, at Step 3.8.

The annotated sample, via either Step 3.6 or Step 3.8, is then placed into the annotated data set, at Step S4 (FIG. 6C). Then, at Step 5, the annotated data set is processed through the learning system so as to improve its performance.

Steps 3.1 (FIG. 6B) through 5 (FIG. 6C) may be repeated until no more samples are available from the data set.

The present invention ultimately provides an improved method, system, and computer program product for providing semantic annotation of data in a software system.

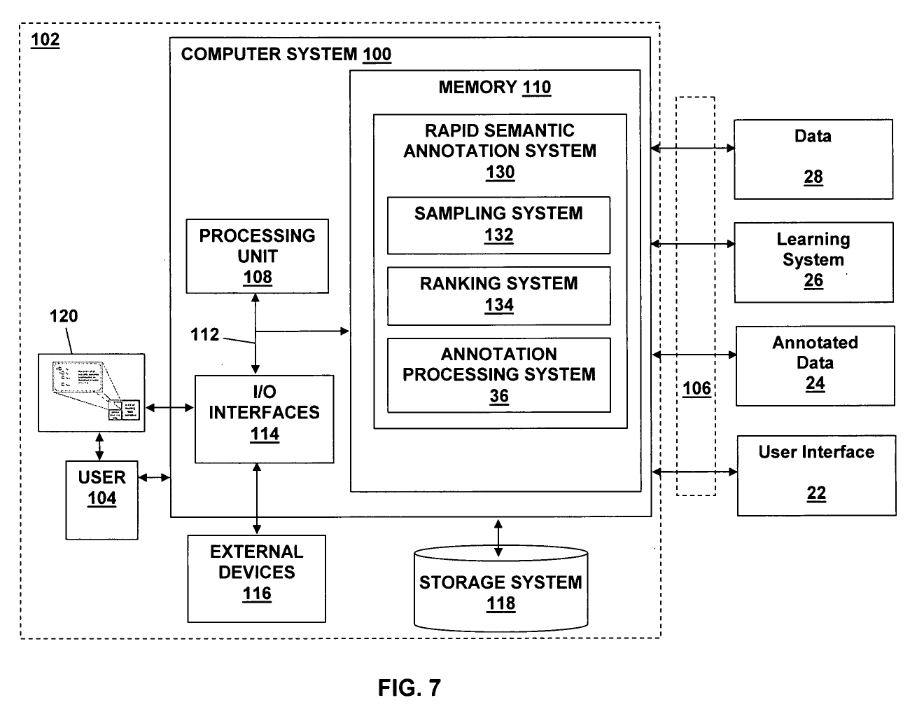

A computer system 100 for providing semantic annotation of data in a software system, in accordance with an embodiment of the present invention is depicted in FIG. 7. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for semantic annotation of data in a software system, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as a Rapid Semantic Annotation System 130, which is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 7 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a Rapid Semantic Annotation System 130 for providing semantic annotation of data in a software system, in accordance with embodiment(s) of the present invention. The Rapid Semantic Annotation System 130 generally includes a Sampling System 132 for providing the processing of “B” samples (e.g., Steps 1.1 through 2 at FIG. 6A), as described above. The Rapid Semantic Annotation System 130 generally includes a Ranking System 134 for providing various hierarchically arranged and/or ranked list(s) of candidates for semantic association to a user (e.g., FIG. 4 and Step 3.2) and selection by the user, as described above. The Rapid Semantic Annotation System 130 generally includes an Annotation Processing System 136 for processing the selected annotation(s) with the sample, the data, and learning system (e.g., Steps 3.6, 3.8, and 4-5), as described above.

The present invention can be offered as a business method on a subscription or fee basis. For example, one or more components of the present invention can be created, maintained, supported, and/or deployed by a service provider that offers the functions described herein for customers. That is, a service provider can be used to provide semantic annotation of data in a software system, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method of semantic annotation of data in a software system, comprising:
receiving an annotated portion of a data set; and
producing a recommended annotation for a data sample of the data set, wherein the recommended annotation is derived from the received annotated portion.

2. The method of claim 1, wherein the software system is selected from a group consisting of a speech recognition system, a video analysis system, and a text search and categorization system.

3. The method of claim 1, wherein the producing further comprises: developing a hierarchy of all available semantic associations to the data set.

4. The method of claim 1, wherein the recommended annotation comprises a ranked list of potential semantic annotations.

5. The method of claim 1, wherein the recommended annotation comprises a label.

6. The method of claim 1, wherein the receiving further comprises:
annotating a first portion of the data set.

7. The method of claim 1, further comprising annotating the data sample with the recommended annotation.

8. A method of semantic annotation of data in a software system, comprising:
providing a data set;
receiving a selected sample from the data set; and
providing a recommended semantic association for the selected sample.

9. The method of claim 8, wherein the recommended semantic association comprises a hierarchical list of semantic associations.

10. The method of claim 8, wherein the recommended semantic association is graphically displayed to a user.

11. The method of claim 8, wherein the software system is selected from a group consisting of: a speech recognition system, a video analysis system, and a text search and categorization system.

12. The method of claim 8, wherein the recommended semantic association is selected from a group consisting of: an annotated data set, a hierarchy of available semantic associations, and a ranked list of potential semantic associations.

13. A system for semantic annotation of data in a software system, comprising:
a system for receiving an annotated portion of a data set; and
a system for producing a recommended annotation for a data sample of the data set, wherein the recommended annotation is derived from the received annotated portion.

14. The system of claim 13, wherein the software system is selected from a group consisting of a speech recognition system, a video analysis system, and a text search and categorization system.

15. The system of claim 13, wherein the system for producing further comprises: a system for developing a hierarchy of all available semantic associations.

16. The system of claim 13, wherein the recommended annotation comprises a ranked list of potential semantic annotations.

17. The system of claim 13, wherein the recommended annotation comprises a label.

18. The system of claim 13, wherein the system for receiving further comprises:
a system for annotating a first portion of the data set.

19. The system of claim 13, further comprising a system for annotating the data sample with the recommended annotation.

20. A program product stored on a computer readable medium for providing semantic annotation of data in a software system, the computer readable medium comprising program code for performing the steps of:
receiving an annotated portion of a data set; and
producing a recommended annotation for a data sample of the data set, wherein the recommended annotation is derived from the received annotated portion.
